(19) United States
(12) Patent Application Publication
(10) Pub. No.: US 2006/0222123 A1
(43) Pub. Date: Oct. 5, 2006

(54) Method and apparatus for monitoring a data eye in a clock and data recovery system

(76) Inventors: Mohammad S. Mobin, Orefield, PA (US); Gregory W. Sheets, Bangor, PA (US); Lane A. Smith, Easton, PA (US)

Correspondence Address: Ryan, Mason & Lewis, LLP, Suite 205, 1300 Post Road, Fairfield, CT, 06824, US

(21) Appl. No.: 11/095,178

(22) Filed: Mar. 31, 2005

(51) Int. Cl. H04B 1/10

(52) U.S. Cl. 375/348

(57) ABSTRACT

Methods and apparatus are provided for monitoring a data eye associated with a received signal. A plurality of samples of the received signal are obtained for each unit interval based on a clock recovered from the received signal, to obtain an estimate of the data eye. According to one aspect of the invention, the samples are obtained substantially simultaneous to a decoding of the received signal. The collected data eye samples can optionally be processed, for example, to collect statistics on the received signal or to determine a distribution of the received signal.

### FIELD OF THE INVENTION

The present invention is related to techniques for clock and data recovery (CDR) techniques and, more particularly, to techniques for evaluating a data eye quality in a CDR system.

### BACKGROUND OF THE INVENTION

In many applications, including digital communications, clock and data recovery (CDR) must be performed before data can be decoded. Generally, in a digital clock recovery system, a reference clock signal of a given frequency is generated together with a number of different clock signals having the same frequency but with different phases. In one typical implementation, the different clock signals are generated by applying the reference clock signal to a delay network. Thereafter, one or more of the clock signals are compared to the phase and frequency of an incoming data stream and one or more of the clock signals are selected for data recovery.

A number of existing digital CDR circuits use voltage controlled delay loops (VCDL) to generate a number of clocks having the same frequency and different phase for data sampling (i.e., oversampling). For example, published International Patent Application No. WO 97/14214, discloses a compensated delay locked loop timing vernier. Generally, the disclosed timing vernier produces a set of timing signals of similar frequency and evenly distributed phase. An input reference clock signal is passed through a succession of delay stages. A separate timing signal is produced at the output of each delay stage. The reference clock signal and the timing signal output of the last delay stage are compared by an analog phase lock controller. The analog phase lock controller controls the delay of all stages so that the timing signal output of the last stage is phase locked to the reference clock. Based on the results of the oversampled data, the internal clock is delayed so that it provides data sampling adjusted to the center of the “eye.” The phase of the VCDL is adjusted to keep up with phase deviations of the incoming data.

FIG. 1 illustrates the transitions in a data stream 100. As shown in FIG. 1, the data is ideally sampled in the middle between two transition points. The phases generated by the VCDL are adjusted to align with the transitions and sample points, respectively. Thus, the internal clock is delayed so that the data sampling is adjusted to the center of the “eye,” in a known manner.

In many CDR applications, it is important to monitor the data eye at the input to a CDR channel. A number of techniques have been proposed or suggested for data eye monitoring that rely on an external oscilloscope positioned at the receiver input. The connection of an external oscilloscope in such a manner, however, loads the input and thereby disturbs the data integrity and alters the results (especially at high data rates). Another approach employs high speed undersampling analog-to-digital (A/D) conversion inside the receiver channel. Such undersampled A/D conversion, however, requires significant area and power, as well as an asynchronous input to sweep the input eye. In addition, such conventional techniques must be performed off-line (i.e., conventional techniques cannot simultaneously monitor the data eye and perform clock recovery for data decoding) and are asynchronous approaches (i.e., are not based on the recovered clock).

A need therefore exists for improved techniques for monitoring a data eye in a CDR system that can operate online, while the CDR system is operating. A further need exists for improved techniques for monitoring a data eye in a CDR system that are synchronized to the recovered clock.

### SUMMARY OF THE INVENTION

Generally, methods and apparatus are provided for monitoring a data eye associated with a received signal. A plurality of samples of the received signal are obtained for each unit interval based on a clock recovered from the received signal, to obtain an estimate of the data eye. According to one aspect of the invention, the samples are obtained substantially simultaneous to a decoding of the received signal. The collected data eye samples can optionally be processed, for example, to collect statistics on the received signal or to determine a distribution of the received signal.

In one embodiment, a plurality of latches are employed to obtain the plurality of samples, and a value of the received signal is estimated by comparing values of two or more latches. The plurality of latches sample the received signal by sampling said received signal for N steps within a unit interval, and for M voltage levels. In another embodiment, a sample and hold circuit is employed to obtain a plurality of values of the received signal. In addition, an analog-to-digital converter optionally converts an output of the sample and hold circuit to a digital value.

A more complete understanding of the present invention, as well as further features and advantages of the present invention, will be obtained by reference to the following detailed description and drawings.

### BRIEF DESCRIPTION OF THE DRAWINGS

FIG. 1 illustrates the transitions in a data stream, often referred to as a “data eye;”

FIG. 2 is a schematic block diagram illustrating a data eye quality monitoring system 200 incorporating features of the present invention;

FIG. 3 illustrates an exemplary VCDL incorporating features of the present invention;

FIG. 4 illustrates the relationship between the various phase outputs of the VCDL of FIG. 3 to the data eye of FIG. 1;

FIG. 5 illustrates the monitoring of the output of the VCDL of FIG. 3 in accordance with one embodiment of the present invention;

FIG. 6 illustrates the sampling of the data eye by the roaming latches of FIG. 4 in further detail;

FIG. 7 is a schematic block diagram illustrating a control system for monitoring of the VCDL output by the roaming latches of FIG. 4;

FIG. 8 is a schematic block diagram illustrating one exemplary implementation of a data eye monitoring system incorporating features of the present invention;

FIG. 9 is a schematic block diagram illustrating an alternate implementation of a data eye monitoring system that sub-samples the data eye at a decimated rate; and

FIG. 10 illustrates a series of data eyes that are selectively sampled in accordance with the embodiment of FIG. 9.

### DETAILED DESCRIPTION

The present invention provides methods and apparatus for monitoring a data eye in a CDR system.

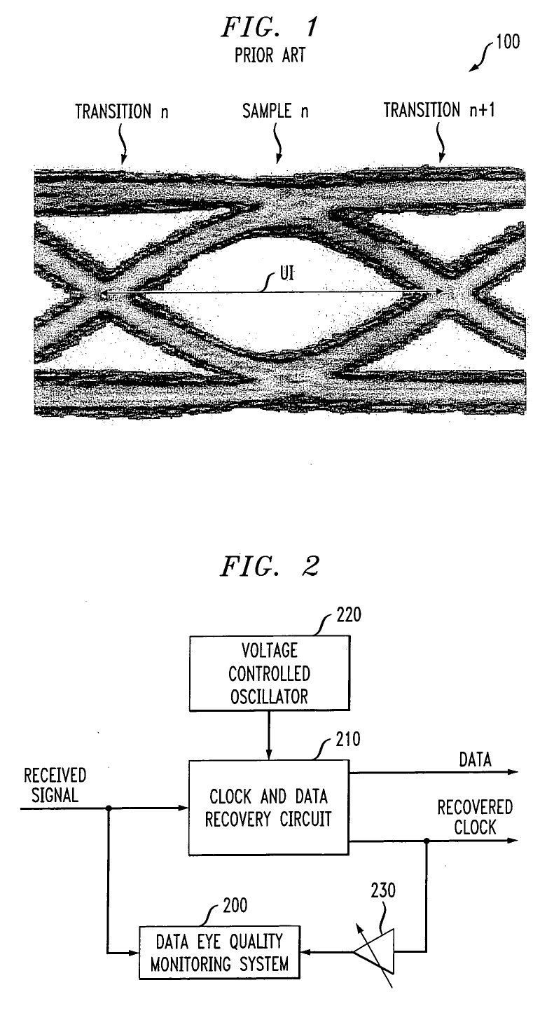

FIG. 2 is a schematic block diagram illustrating a data eye quality monitoring system 200 incorporating features of the present invention. As shown in FIG. 2, a received signal is processed by a clock and data recovery circuit 210 to generate the decoded data and recovered clock, in a known manner. Generally, the clock and data recovery circuit 210 adjusts a clock signal generated by a voltage controlled delay line 220 to maintain a phase alignment between the recovered clock and the received signal.

According to one aspect of the invention, a data eye quality monitoring system 200 is provided that samples the data eye associated with the received signal. As discussed hereinafter, the data eye quality monitoring system 200 can evaluate the data eye while the clock and data recovery circuit 210 is operating. In addition, as shown in FIG. 2 and discussed further below, the data eye quality monitoring system 200 is clocked using the recovered clock. In one embodiment discussed herein, a variable delay stage 230 can be employed to tune the phase of the recovered clock in order to sample the received signal in the time domain. Thus, the data eye monitoring is synchronized to the recovered clock.

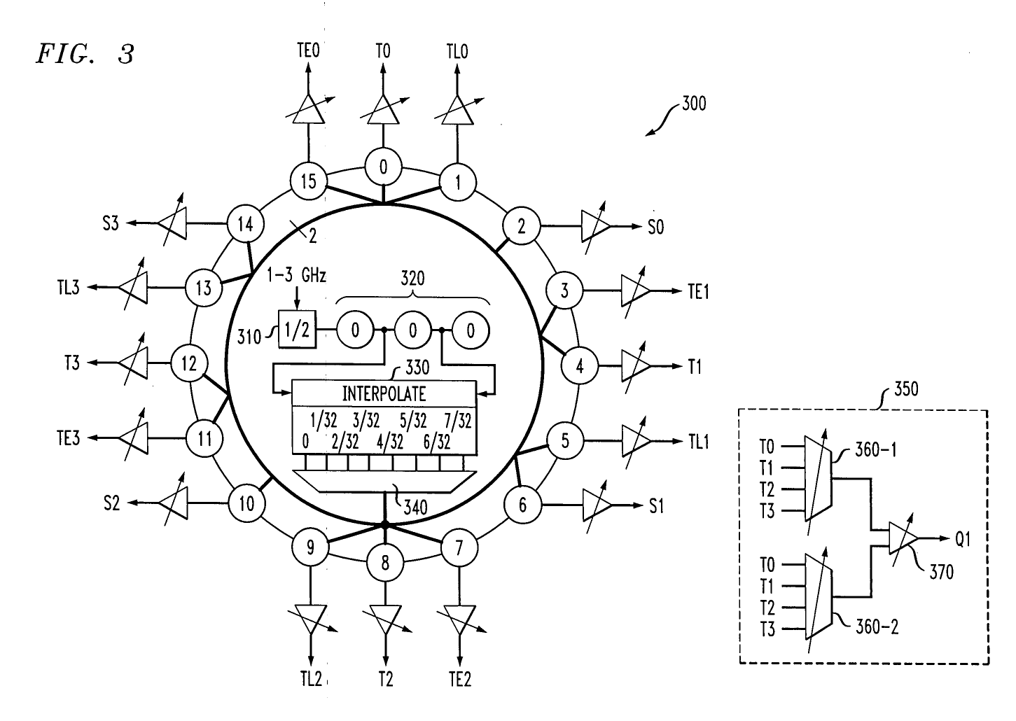

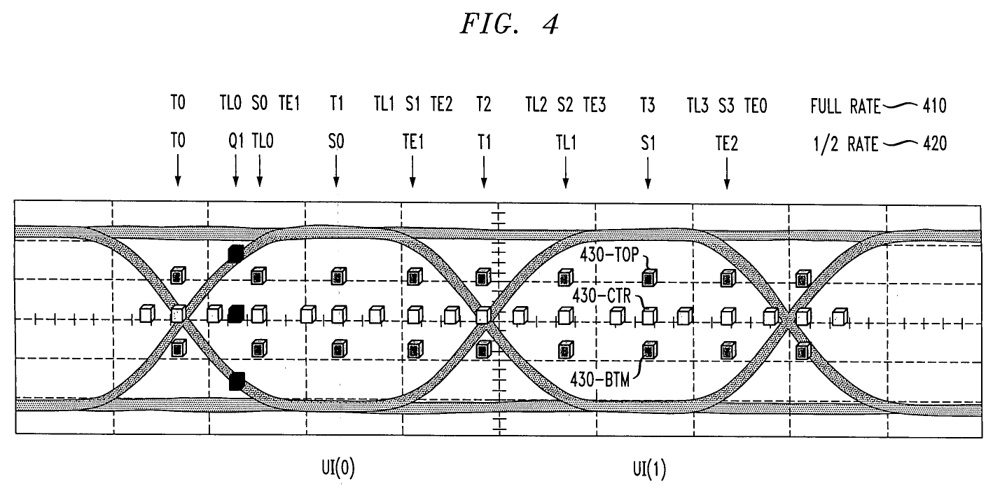

FIG. 3 illustrates an exemplary VCDL 300 incorporating features of the present invention. The exemplary VCDL 300 employs coarse phase control using injection point control, as well as a fine phase control provided by a central interpolator 330. Thus, the PLL signal that is injected into the VCDL 300 is first interpolated to provide fine phase control. Following the fine phase control, the injection point may optionally be adjusted to provide a coarse phase control, as further described in U.S. patent application Ser. No. 10/999,889, filed Nov. 30, 2004, entitled, “Voltage Controlled Delay Loop With Central Interpolator,” incorporated by reference herein.

As shown in FIG. 3, the input PLL signal, for example, having a frequency of 1-3 GHz, is applied to an optional frequency divider 310 that reduces the frequency, for example, in half. The output of the central interpolator can optionally be injected in any delay stage in the VCDL loop. The output of the frequency divider 310 is then applied to a delay stage 320 having one or more delay elements (e.g., each providing a ¼ UI delay). The delay stage 320 is connected to the central interpolator 330 such that the left and right inputs to the central interpolator 330 are separated by at least one delay element, as shown in FIG. 3.

The exemplary central interpolator 330 provides, for example, 8 distinct phases (over ¼ UI range), between each coarse phase setting. A multiplexer 340 selects the desired phase. If the phase must be adjusted beyond the granularity provided by the central interpolator 330 (i.e., more than a ¼ UI), then a coarse phase adjustment is made by adjusting the injection point (providing a granularity of ¼ UI).

As shown in FIG. 3, the quadrature phase outputs of the VCDL 300 (T0, T1, T2, T3), are applied to an interpolating multiplexer 350 that can generate N taps between any two quadrature clocks. The interpolating multiplexer 350 comprises first and second multiplexers 360-1 and 360-2 that each receive the quadrature phase outputs of the VCDL (T0, T1, T2, T3). Each multiplexer 360-1 and 360-2 selects a desired phase that is interpolated by an interpolator 370. The output of the interpolator 370 is an interpolation clock, Q1, that has a phase that is between the phases of the clocks selected by the multiplexers 260-1 and 260-2, in a known manner.

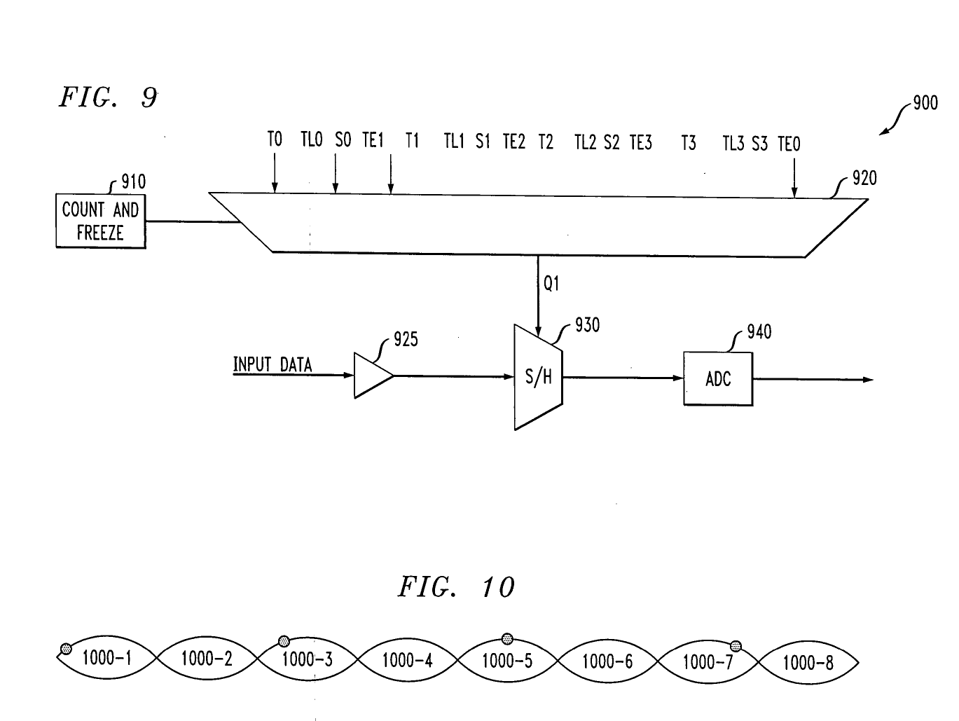

FIG. 4 illustrates the relationship between the various phase outputs of the VCDL of FIG. 3 to the data eye 100 of FIG. 1, for a full rate clock 410 and a half rate clock 420. As used herein, the notation “TEn” indicates an early transition phase n, the notation “TLn” indicates a late transition phase n and the notation “Sn” indicates a sample point n. In addition, according to the present invention, the data eye associated with the received data is sampled. In one exemplary embodiment, discussed below in conjunction with FIGS. 4 through 8, the data eye 100 is sampled using a plurality of latches, and the values sampled by the plurality of latches are compared to infer the location of the data eye 100. In another embodiment, discussed below in conjunction with FIGS. 9 and 10, the data eye 100 is sampled using a sample and hold circuit that measures the data eye directly.

In one exemplary embodiment shown in FIG. 4, a set of three latches (430-top, 430-ctr, 430-btm) are employed to sample the data eye 100. Generally, each latch has a data input, a clock input and an output. The received data (i.e., the data eye) is applied to the data input and the interpolated clock Q1 from the VCDL 300 is applied as the clock input (see also variable delay 230 in FIG. 2). The set of three latches 430-top, 430-ctr, 430-btm can be programmed horizontally to move left and right with N taps per data eye (for example, by interpolating the phase outputs applied to the clock input of each latch). In this manner, the data eye quality monitoring system 200 is clocked using the recovered clock. Thus, the data eye monitoring is synchronized to the recovered clock.

In addition, the zero cross center latch 430-ctr is always fixed in a vertical direction, for example, at the zero cross. The top and bottom roaming latches 430-top, 430-btm can move up and down in a vertical direction from the zero cross latch 430-ctr by programming a variable threshold voltage that is applied to the data input of each latch with M voltage levels. The output interpolation clock Q1 of FIG. 3 can be distributed to the roaming latches 430-top, 430-ctr, 430-btm, hereinafter, collectively referred to as roaming latches 430.

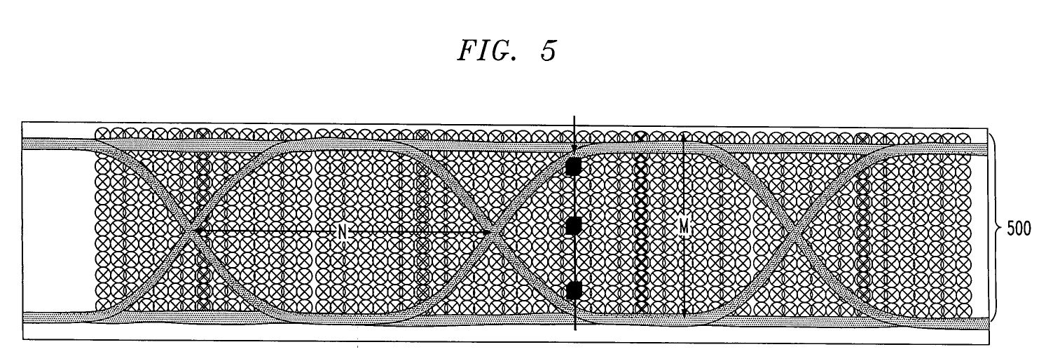

FIG. 5 illustrates the monitoring of the output of the VCDL 300 of FIG. 3 in accordance with one embodiment of the present invention. As shown in FIG. 5, the roaming three latches 430-top, 430-ctr and 430-btm of FIG. 4 can be programmed to move horizontally and vertically to provide N×M roaming latch options, with N latch options per data eye having a time orientation (e.g., horizontal) and M latch options per data eye having a voltage orientation (e.g., vertical). In this manner, the data eye value can be sampled over N×M positions within the eye to obtain an accurate visualization of the data eye 100. In one exemplary embodiment, there are N=64 steps per unit interval (UI) in the horizontal direction and M=128 steps in the vertical direction (64 steps above the zero crossing and 64 steps below the zero crossing).

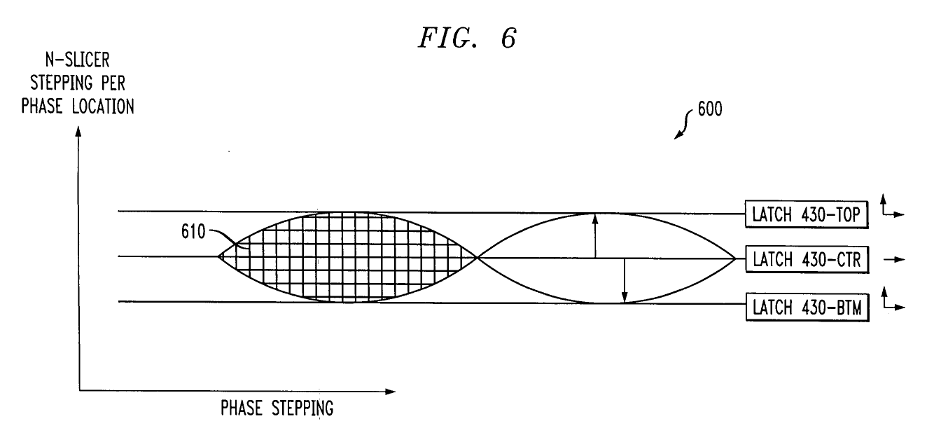

FIG. 6 illustrates the sampling of the data eye by the roaming latches 430, in further detail. As previously indicated, roaming three latches 430-top, 430-ctr, 430-btm can be programmed horizontally to move left and right with N taps per data eye (for example, by interpolating the phase outputs). In addition, the zero cross center latch 430-ctr is always fixed in a vertical direction, for example, at the zero cross, as shown in FIG. 6. The top and bottom roaming latches 430-top, 430-btm can move up and down in a vertical direction from the zero cross latch 430-ctr by programming a variable threshold voltage input to each latch with M voltage levels.

Thus, whether or not the value of the center latch 430-ctr matches the value of the top and bottom latches, 430-top, 430-btm, provides an indication of boundaries of the data eye 100. If the center latch 430-ctr has the same value as the top latch 430-top, they are said to match. Thus, for samples taken inside a data eye, such as the data eye 610, it would be expected that the value of the center latch 330-ctr matches the value of the top and bottom latches, 430-top, 430-btm. For samples taken along the boundary of the data eye, such as the data eye 610, it would be expected that some of the values of the center latch 430-ctr will match some of the values of the top and bottom latches, 430-top, 430-btm. For samples taken outside a data eye, such as the data eye 610, it would be expected that the value of the center latch 430-ctr will not match the value of the top and bottom latches, 430-top, 430-btm.

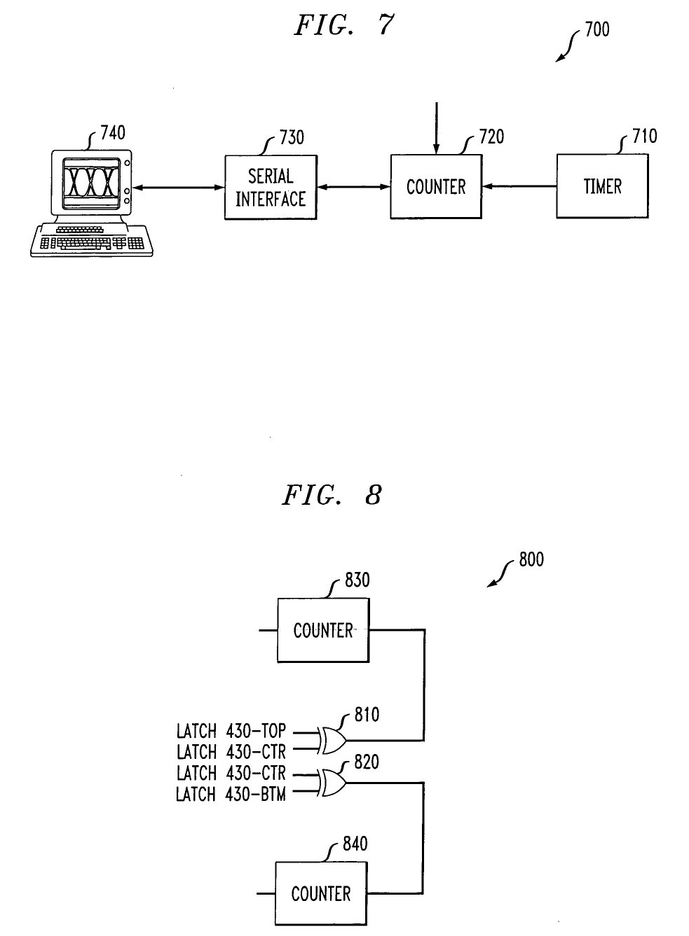

FIG. 7 is a schematic block diagram illustrating a control system 700 for monitoring of the VCDL output by the roaming latches 430. In one exemplary implementation, for each of the N horizontal positions associated with a given eye, the roaming latches 430 are stepped through each of the M vertical levels to obtain the data eye samples. For each position in the N×M array of sampled locations, the respective values of the roaming latches 430 are evaluated for a predefined duration, controlled by a timer 710. In one exemplary implementation discussed further below in conjunction with FIG. 8, for each position in the N×M array of sampled locations, a counter 720 counts the number of mismatches during the predefined duration between the center latch 430-ctr and the top and bottom latches, 430-top, 430-btm. The count metric generated by the counter 720 is provided, for example, via a serial interface 730 to a computing device 740, such as a personal computer or an 8051 microprocessor, for further analysis.

Generally, once the data for the N×M points is loaded into the computing device 740, the data can be analyzed and the data eye 100 with intensity information, such as a hit rate, can be drawn on the screen. For a given position in the N×M array of sampled locations, the hit rate can be defined, for example, as the number of mismatches during the predefined duration between the center latch 430-ctr and the top or bottom latch, 430-top, 430-btm, associated with the position. For example, if a given position is above the zero crossing point, the value of the center latch 430-ctr is compared to the value of the top latch, 430-top. In this manner, the resulting viewable output can be presented without disturbing the data integrity.

FIG. 8 is a schematic block diagram illustrating one exemplary implementation of a data eye monitoring system 800 incorporating features of the present invention. As shown in FIG. 8, the outputs of the roaming latches 430 are applied to a pair of exclusive OR (XOR) gates 810, 820, in the manner shown in FIG. 8. A first XOR gate 810 compares the value of the center latch 430-ctr to the value of the top latch 430-top. If the values of the center latch 430-ctr and top latch 430-top match, the XOR gate 810 will generate a binary value of 0 and if the values of the center latch 430-ctr and top latch 430-top do not match, the XOR gate 810 will generate a binary value of 1, in a known manner. Thus, a “hit” occurs for points above the zero crossing when the values of the center latch 430-ctr and top latch 430-top do not match.

Likewise, a second XOR gate 820 compares the value of the center latch 430-ctr to the value of the bottom latch 430-btm. If the values of the center latch 430-ctr and bottom latch 430-btm match, the XOR gate 820 will generate a binary value of 0 and if the values of the center latch 430-ctr and bottom latch 430-btm do not match, the XOR gate 820 will generate a binary value of 1, in a known manner. Thus, a “hit” occurs for points below the zero crossing when the values of the center latch 430-ctr and bottom latch 430-btm do not match.

As shown in FIG. 8, the exemplary data eye monitoring system 800 includes one or more counters 830, 840 for counting the “hit rate” for points above and below the zero crossing, respectively. It is noted that a single shared counter 830 can be employed to count the “hit rate” for points above and below the zero crossing, as would be apparent to a person of ordinary skill in the art.

FIG. 9 is a schematic block diagram illustrating an alternate implementation of a data eye monitoring system 900 that sub-samples the data eye 100 at a decimated rate. In other words, as shown in FIG. 10, the data eye monitoring system 900 does not sample each data eye 100, but rather every other data eye 1000 is sampled, such as each odd data eye 1000-1, 1000-3, 1000-5, 1000-7.

In the exemplary embodiment of FIG. 9, the data eye 100 is sampled using a sample and hold circuit 930 that measures the data eye directly. As shown in FIG. 9, the received data is applied to the input of the sample and hold circuit 930. In addition, the clock signal Q1 discussed above, from the VCDL 300, is applied to the clock input of the sample and hold circuit 930. The various phases of the VCDL 300 are applied to a multiplexer 920 that selects a phase under control of a counter 910. The sample and hold circuit 930 samples the received data (i.e., the data eye) and provides a voltage level that is applied to an analog-to-digital converter 940.

A plurality of identical die are typically formed in a repeated pattern on a surface of the wafer. Each die includes a device described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

It is to be understood that the embodiments and variations shown and described herein are merely illustrative of the principles of this invention and that various modifications may be implemented by those skilled in the art without departing from the scope and spirit of the invention.

We claim:

1. A method for monitoring a data eye associated with a received signal, comprising:
obtaining a plurality of samples of said received signal for each unit interval based on a clock recovered from said received signal.

2. The method of claim 1, wherein said obtaining step is performed substantially simultaneous to a decoding of said received signal.

3. The method of claim 1, wherein said obtaining step further comprises the steps of sampling said received signal using a plurality of latches and estimating a value of said received signal by comparing values of said latches.

4. The method of claim 3, wherein said plurality of latches sample said received signal by sampling said received signal for N steps within a unit interval.

5. The method of claim 3, wherein said plurality of latches sample said received signal by sampling said received signal for M voltage levels.

6. The method of claim 3, wherein said plurality of latches are clocked using said clock recovered from said received signal.

7. The method of claim 1, wherein said obtaining step further comprises the steps of sampling said received signal using a sample and hold circuit to obtain a plurality of values of said received signal.

8. The method of claim 7, further comprising the step of converting an output of said sample and hold circuit to a digital value.

9. The method of claim 1, further comprising the step of collecting statistics on said received signal.

10. The method of claim 1, further comprising the step of determining a distribution of said received signal.

11. A circuit for monitoring a data eye associated with a received signal, comprising:
a plurality of latches for obtaining a plurality of samples of said received signal for each unit interval based on a clock recovered from said received signal.

12. The data eye monitoring circuit of claim 11, wherein said plurality of latches obtain said plurality of samples substantially simultaneous to a decoding of said received signal.

13. The data eye monitoring circuit of claim 11, wherein a value of said received signal is estimated by comparing values of said latches.

14. The data eye monitoring circuit of claim 13, wherein said plurality of latches sample said received signal by sampling said received signal for N steps within a unit interval.

15. The data eye monitoring circuit of claim 13, wherein said plurality of latches sample said received signal by sampling said received signal for M voltage levels.

16. The data eye monitoring circuit of claim 13, wherein said plurality of latches are clocked using said clock recovered from said received signal.

17. A circuit for monitoring a data eye associated with a received signal, comprising:
a sample and hold circuit for obtaining a plurality of samples of said received signal for each unit interval based on a clock recovered from said received signal.

18. The data eye monitoring circuit of claim 17, wherein said plurality of samples are obtained substantially simultaneous to a decoding of said received signal.

19. The data eye monitoring circuit of claim 17, further comprising a analog-to-digital converter to convert an output of said sample and hold circuit to a digital value.

20. An integrated circuit, comprising:
a circuit for monitoring a data eye associated with a received signal, comprising means for obtaining a plurality of samples of said received signal for each unit interval based on a clock recovered from said received signal.

21. The integrated circuit of claim 20, wherein said means for obtaining further comprises a plurality of latches and wherein a value of said received signal is estimated by comparing values of said latches.

22. The integrated circuit of claim 20, wherein said means for obtaining further comprises a sample and hold circuit to obtain a plurality of values of said received signal.

23. The integrated circuit of claim 22, further comprising a analog-to-digital converter to convert an output of said sample and hold circuit to a digital value.
